(19) United States
(12) Patent Application Publication
(10) Pub. No.: US 2023/0254463 A1
(43) Pub. Date: Aug. 10, 2023

(54) FOCAL LENGTH CALCULATION METHOD, DISPLAY METHOD PERFORMED BY PROJECTOR, AND IMAGING SYSTEM

(71) Applicant: SEIKO EPSON CORPORATION, Tokyo (JP)

(72) Inventor: Yuki MORI, Matsumoto-shi (JP)

(73) Assignee: SEIKO EPSON CORPORATION, Tokyo (JP)

(21) Appl. No.: 18/166,880

(22) Filed: Feb. 9, 2023

(30) Foreign Application Priority Data
Feb. 10, 2022 (JP) 2022-019182

(51) Int. Cl. H04N 9/31

(52) U.S. Cl. CPC H04N 9/3185

(57) ABSTRACT

A processor includes an image acquirer acquiring image data produced by capturing an image of a rectangular subject, a four side identifier identifying the sides of a quadrilateral corresponding to the subject, a side L1, a side L2 facing the side L1, a side L3, and a side L4 facing the side L3, in the image indicated by the image data, a coordinate identifier identifying the coordinates of a vertical vanishing point being the intersection of an extension of the side L1 and an extension of the side L2, and the coordinates of a horizontal vanishing point being the intersection of an extension of the side L3 and an extension of the side L4, and a calculator calculating the focal length of an imaging apparatus having captured the image of the subject based on the coordinates of the vertical vanishing point and the coordinates of the horizontal vanishing point.

The present application is based on, and claims priority from JP Application Serial Number 2022-019182, filed Feb. 10, 2022, the disclosure of which is hereby incorporated by reference herein in its entirety.

### BACKGROUND

### 1. Technical Field

The present disclosure relates to a focal length calculation method, a display method performed by a projector, and an imaging system.

### 2. Related Art

Projectors in recent years are compact, lightweight, and portable and therefore used at a variety of locations. It is therefore necessary to correct projected images in accordance with the location where the projector is used and the screen with which the projector is used.

To this end, there is, for example, a known technique for providing a projector with a camera, capturing a projected image with the camera, and correcting a projected image based on the captured image, such as the technique described in WO 2013/038656. In the technique, internal parameters such as the focal length of the camera are treated as values specified in advance.

In recent years, most information terminal apparatuses, such as smartphones, each have an imaging function. It is therefore conceivable to use an image captured by an information terminal apparatus, but it is difficult for an average user to grasp the internal parameters of the camera built in the information terminal apparatus. To overcome the difficulty described above, there is, for example, a known technique for using an image of a checkerboard captured by the camera to determine the internal parameters of the camera, for example, the focal length, as described in JP-A-2021-1113020.

The technique described in JP-A-2021-1113020, however, has a problem of necessity of using the camera to capture an image of the checkerboard disposed in a variety of postures, which requires a lot of time and effort.

### SUMMARY

A focal length calculation method according to an aspect of the present disclosure includes acquiring image data produced by capturing an image of a rectangular subject, identifying sides of a quadrilateral corresponding to the subject, a first side, a second side facing the first side, a third side, and a fourth side facing the third side, in the image indicated by the image data, identifying coordinates of a first point that is an intersection of an extension of the first side and an extension of the second side, and coordinates of a second point that is an intersection of an extension of the third side and an extension of the fourth side, and calculating a focal length of an apparatus that captures the image of the subject based on the coordinates of the first point and the coordinates of the second point.

A display method performed by a projector according to another aspect of the present disclosure includes acquiring image data produced by capturing an image of a rectangular projection region, identifying sides of a quadrilateral corresponding to the projection region, a first side, a second side facing the first side, a third side, and a fourth side facing the third side, in the image indicated by the image data, identifying coordinates of a first point that is an intersection of an extension of the first side and an extension of the second side, and coordinates of a second point that is an intersection of an extension of the third side and an extension of the fourth side, calculating a focal length of an apparatus that captures the image of the projection region based on the coordinates of the first point and the coordinates the second point, identifying the coordinates of a third point that is an intersection of a straight line that connects the first point and the second point to each other and an extension of a diagonal of the quadrilateral, calculating an aspect ratio of the projection region based on the coordinates of the first point, the coordinates of the second point, and the coordinates of the third point, and projecting the image based on the calculated aspect ratio of the projection region.

An imaging system according to another aspect of the present disclosure includes a processor, and the processor acquires image data produced by capturing an image of a rectangular subject, identifies sides of a quadrilateral corresponding to the subject, a first side, a second side facing the first side, a third side, and a fourth side facing the third side, in the image indicated by the image data, identifies coordinates of a first point that is an intersection of an extension of the first side and an extension of the second side, and coordinates of a second point that is an intersection of an extension of the third side and an extension of the fourth side, and calculates a focal length of an apparatus that captures the image of the subject based on the coordinates of the first point and the coordinates of the second point.

### BRIEF DESCRIPTION OF THE DRAWINGS

FIG. 1 shows the configuration of an imaging system according to an embodiment.

FIG. 2 shows the hardware configuration of an information terminal apparatus in the imaging system.

FIG. 3 is a block diagram showing the functional configuration of software provided in the information terminal apparatus.

FIG. 4 shows the hardware configuration of a projector in the imaging system.

FIG. 5 is a block diagram showing the functional configuration of software provided in the projector.

FIG. 6 shows a vanishing point.

FIG. 7 shows a camera coordinate system and a world coordinate system.

FIG. 8 shows orthogonality of vanishing points in a normalized camera coordinate system.

FIG. 9 describes a diagonal vanishing point.

FIG. 10 is a flowchart showing the action of the information terminal apparatus and the projector in the imaging system.

### DESCRIPTION OF EXEMPLARY EMBODIMENTS

The imaging system according to the embodiment of the present disclosure will be described below with reference to the drawings. It is noted that the dimensions and scale of each portion in the drawings differ from actual values as appropriate. A variety of technically preferable restrictions are imposed on the embodiment described below, which is a preferable specific example, and the scope of the present disclosure is, however, not limited to the embodiment unless the following description states that particular restrictions are imposed on the present disclosure.

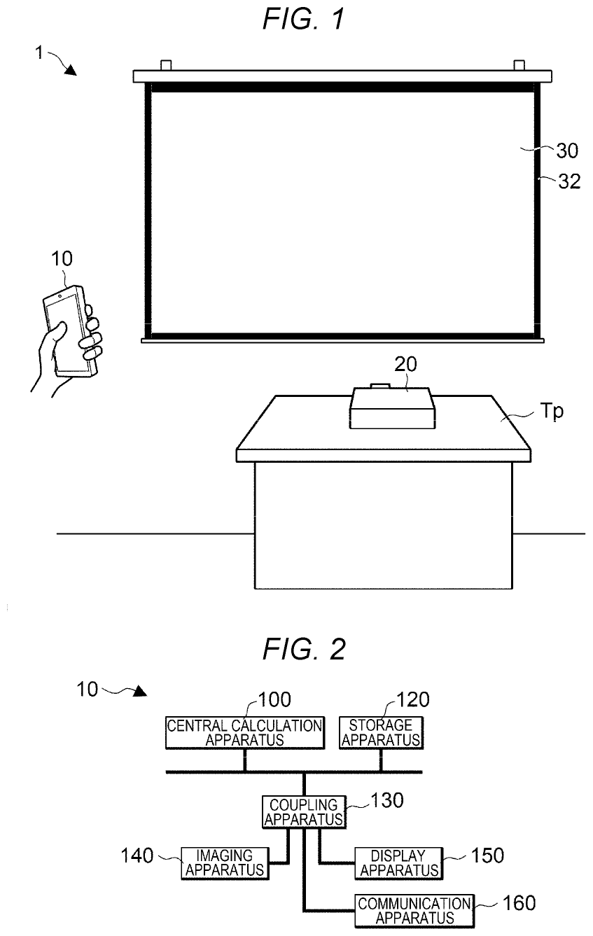

FIG. 1 shows the configuration of an imaging system 1 according to the embodiment.

The imaging system 1 includes an information terminal apparatus 10 and a projector 20. The information terminal apparatus 10 is, for example, a smartphone or a portable tablet apparatus, and has imaging and communication functions. In the present embodiment, the information terminal apparatus 10 captures an image of the shape of a screen 30, in detail, the region, of the screen 30, where the projector 20 is designed to project an image.

For convenience of the description, the region, of the screen 30, where the projector 20 is designed to project an image is simply referred to as a projection region. The screen 30 shown in FIG. 1 is a black mask screen with the four sides thereof surrounded with black edges. The projection region is therefore in an exact sense a white region surrounded by a rectangular screen frame 32, which is the black mask. It is, however, noted that identifying the shape of the screen frame 32 is substantially equal to identifying the projection region surrounded by the screen frame 32.

The screen 30 may instead be an entirely white screen without a black mask. In the case of a screen without a black mask, the projection region can be identified, for example, by the difference in contrast between the white surface of the screen and the surface behind the screen (wall surface).

The projector 20 enlarges an image based on an image signal supplied from a host apparatus that is not shown and projects the enlarged image on the screen 30. FIG. 1 shows a case where the projector 20 is placed on the upper surface of a teacher's platform Tp and the screen 30 is suspended along a wall surface.

FIG. 2 shows the hardware configuration of the information terminal apparatus 10. The information terminal apparatus 10 includes a central calculation apparatus 100, a storage apparatus 120, a coupling apparatus 130, an imaging apparatus 140, a display apparatus 150, and a communication apparatus 160.

The central calculation apparatus 100 is a processor, is formed, for example, of one or more processing circuits, such as a CPU (central processing unit), and integrally controls the elements of the information terminal apparatus. The central calculation apparatus 100 may not be a CPU and may instead be formed of a DSP (digital signal processor), an ASIC (application specific integrated circuit), or any other circuit.

The storage apparatus 120 is one or more memories each formed of a known recording medium, for example, a magnetic or semiconductor recording medium, and stores programs executed by the central calculation apparatus 100, a variety of types of data used by the central calculation apparatus 100, and data on captured images. A combination of a plurality of types of recording media may instead constitute the storage apparatus 120. Still instead, a portable recording medium attachable to and detachable from the information terminal apparatus 10, or an external recording medium (online storage, for example) with which the information terminal apparatus 10 can communicate via a communication network can be used as the storage apparatus 120.

The coupling apparatus 130 is an interface to which the imaging apparatus 140, the display apparatus 150, and the communication apparatus 160 are coupled. The coupling apparatus 130 includes, for example, an interface circuit. The imaging apparatus 140 includes a lens, an image sensor, and other component, and is capable of capturing an image, for example, through a user's operation. In the present embodiment, the imaging apparatus 140 particularly captures an image of the screen frame 32. The imaging apparatus 140 is, for example, a camera.

Data on an image captured by the imaging apparatus 140 is supplied to the display apparatus 150, and an image based on the data is displayed on the display apparatus 150 for confirmation by the user. The display apparatus 150 includes, for example, a display panel.

The communication apparatus 160 is an apparatus for communicating information with other instruments other than the information terminal apparatus 10. Specifically, in the present embodiment, the communication apparatus 160 transmits image data on an image captured by the imaging apparatus 140 and showing the screen frame 32 to the projector 20. The communication apparatus 160 includes, for example, an antenna for wireless communication and a coupling terminal for wired communication.

In the present description, the term “apparatus” may be replaced with other terms such as a circuit, a device, or a unit. The elements of the information terminal apparatus 10 are each formed of one or more instruments. Part of the elements of the information terminal apparatus 10 may be omitted.

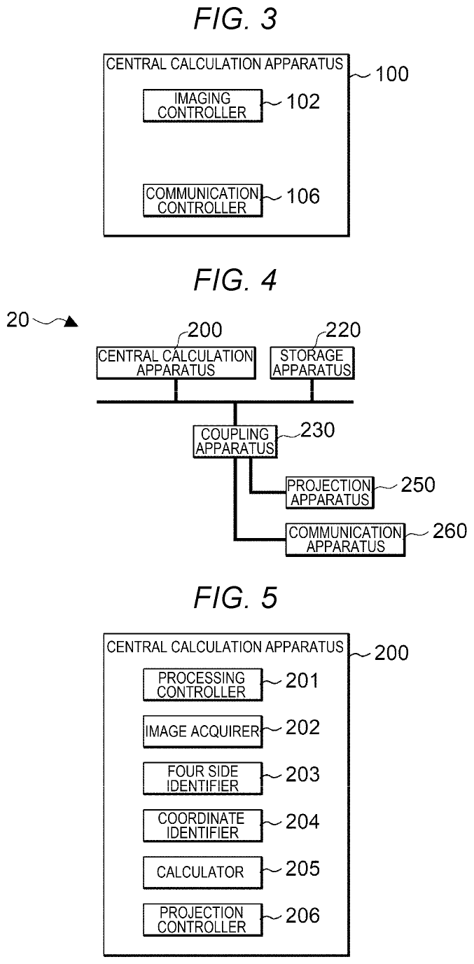

FIG. 3 is a block diagram showing the functions achieved by the central calculation apparatus 100 in the information terminal apparatus 10. As shown in FIG. 3, the central calculation apparatus 100 executes a variety of programs stored in the storage apparatus 120 to achieve an imaging controller 102 and a communication controller 104.

FIG. 4 shows the hardware configuration of the projector 20. The projector 20 includes a central calculation apparatus 200, a storage apparatus 220, a coupling apparatus 230, a projection apparatus 250, and a communication apparatus 260. The central calculation apparatus 200, the storage apparatus 220, the coupling apparatus 230, and the communication apparatus 260 in the projector 20 are identical to the central calculation apparatus 100, the storage apparatus 120, the coupling apparatus 130, and the communication apparatus 160 in the information terminal apparatus 10 described above.

The projection apparatus 250 in the projector 20 is an optical engine that enlarges an image based on the image signal supplied from the host apparatus, which is not shown, and projects the enlarged image onto the screen 30. The projection apparatus includes, for example, a light source, a light modulator, and a projection lens, none of which is shown. The light modulator can, for example, be a liquid crystal panel or a digital mirror device. The projection apparatus 250 is not essential in the present embodiment and will therefore not be described in detail.

FIG. 5 is a block diagram showing the functions achieved by the central calculation apparatus 200 in the projector 20.

The central calculation apparatus 200 executes a variety of programs stored in the storage apparatus 220 to achieve a processing controller 201, an image acquirer 202, a four side identifier 203, a coordinate identifier 204, a calculator 205, and a projection controller 206, as shown in FIG. 5.

Description will be given for the principle in accordance with which the focal length of the imaging apparatus 140 is calculated in the present embodiment.

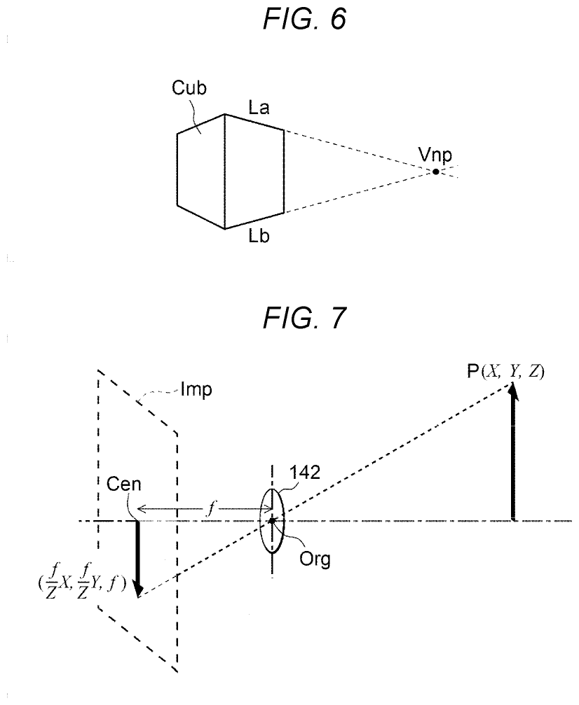

FIG. 6 shows, for example, an image of a cuboid Cub viewed sideways and captured by the imaging apparatus 140. In the actual coordinate system (world coordinate system), sides La and Lb of the cuboid Cub are parallel to each other and do not intersect with each other, but in the coordinate system of the captured image, extensions of the sides La and Lb may intersect with each other in the coordinate system of a captured image. The intersection is called a vanishing point Vnp.

FIG. 7 describes the relationship between a captured image and an actual object. As shown in FIG. 7, an image plane Imp, where the captured image is located, coincides with the imaging surface of the image sensor of the imaging apparatus 140, and is located at a point separate from a center point (focal point) Org of a lens 142 in the imaging apparatus 140 by a focal length f of the lens 142. The actual lens 142, which is a combination of a plurality of lenses, is drawn in a simplified form in FIG. 7.

When an image of an object P located at coordinates (X, Y, Z) in the world coordinate system having an origin at the center point Org is captured by the imaging apparatus 140, the object P is projected onto coordinates (X·f/Z, Y·f/Z, f) in a camera coordinate system.

Coordinate representing information in the camera coordinate system is expressed in pixels of the image sensor, unlike the world coordinate system, which is expressed in meters.

In general, the component Z is missing in information outputted from an image sensor, and the information is outputted with the upper left end of an image being the origin.

The imaging apparatus 140 of the information terminal apparatus 10 does not show the user the exact center point Org of the lens 142 in many cases, but the center point Cen of a captured image basically coincides with the center point Org of the lens 142 (except for component Z). The coordinates of image data outputted from the image sensor can therefore be converted to those in the camera coordinate system by shifting the coordinates by half the vertical size of the pixels of the image sensor and half the horizontal size of the pixels thereof.

For example, when a captured image has a horizontal resolution of 1920 pixels and a vertical resolution of 1080 pixels, and when certain coordinates are (Xa, Ya) expressed in pixels in an image outputted from the image sensor, the coordinates can be converted into those in the camera coordinate system by horizontally and vertically shifting the coordinates by half the resolution. Specifically, when coordinates (Xa, Ya) expressed in pixels in an image are converted into coordinates (Xa-960, Ya-560) in the camera coordinate system.

Since it is difficult to analyze images captured at different focal lengths in a unified manner, a coordinate system called a normalized camera coordinate system is used in projective geometry. In the normalized camera coordinate system, the focal length f is normalized to “1”. In the camera coordinate system, the coordinates (X·f/Z, Y·f/Z, f) can be expressed as (X/Z, Y/Z, 1) in the normalized camera coordinate system.

In practice, since information on the component Z is missing in the camera coordinate system, the coordinates in the normalized camera coordinate system are provided by dividing the components X and Y by the focal length f.

The normalized camera coordinate system offers several conveniences. One of the conveniences is that a vertical vanishing point and a horizontal vanishing point have orthogonality. This point will be described.

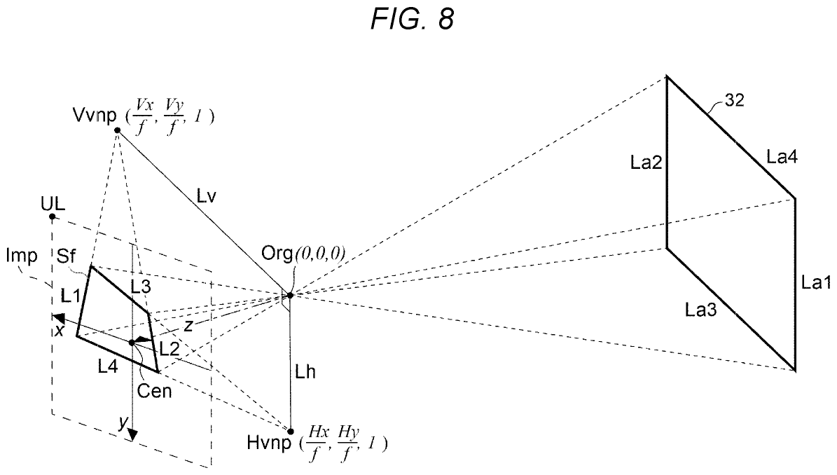

When an image of the rectangular screen frame 32 is captured by the imaging apparatus 140 of the information terminal apparatus 10, the screen frame 32 is expressed in the image plane Imp by a quadrilateral Sf shown in FIG. 8. The quadrilateral Sf is formed of the following sides L1 to L4. In detail, the quadrilateral Sf is formed of four sides in the image plane Imp, a side L1, which is the projection of a side La1 of the screen frame 32, a side L2, which is the projection of a side La2 of the screen frame 32, a side L3, which is the projection of a side La3 of the screen frame 32, and a side L4, which is the projection of a side La4 of the screen frame 32.

The actual screen frame 32 is so shaped that the sides La1 and La2 are parallel to each other, as are the sides La3 and La4, and the sides La1 and La2 are orthogonal to the sides La3 and La4.

In FIG. 7 or 8, the imaging surface of the image sensor is drawn with a broken line, and the image plane Imp specified in the camera coordinate system is an imaginary plane enlarged so as to contain the imaging surface.

The quadrilateral Sf, which is the projection of the screen frame 32 onto the image plane Imp, is so configured that a vertical vanishing point Vvnp, which is the intersection of an extension of the side L1 and an extension of the side L2, and a horizontal vanishing point Hvnp, which is the intersection of an extension of the side L3 and an extension of the side L4, have the following relationship. In detail, in the normalized camera coordinate system, a straight line Lv, which connects the vertical vanishing point Vvnp to the origin, which coincides with the lens center point Org, and a straight line Lh, which connects the horizontal vanishing point Hvnp to the origin, which coincides with the lens center point Org, are orthogonal to each other at the center point Org.

The camera coordinate system can be converted into the normalized camera coordinate system by dividing each coordinate in the camera coordinate system by the focal length f. In other words, if dividing each coordinate by a certain value F causes the vertical vanishing point Vvnp and the horizontal vanishing point Hvnp to have orthogonality, it can be said that F is equal to the focal length f.

Now, let (Vx/f, Vy/f, 1) be the coordinates of the converted vertical vanishing point Vvnp expressed in the normalized camera coordinate system, and let (Hx/f, Hy/f, 1) be the coordinates of the converted horizontal vanishing point Hvnp expressed in the normalized camera coordinate system. In the normalized camera coordinate system, the coordinate z is “1”, as described above.

Since the straight line Lv, which connects the vertical vanishing point Vvnp (Vx/f, Vy/f, 1) to the center point Org, and the straight line Lh, which connects the horizontal vanishing point Hvnp (Hx/f, Hy/f, 1) to the center point Org, are orthogonal to each other at the origin, the inner product of the coordinates of the two vanishing points is zero. Expression (1) below is therefore satisfied.

$$\frac{HxVx}{{f}^{2}} + \frac{HyVy}{{f}^{2}} + 1 = 0 \qquad ( 1 )$$

Note that the straight lines Lv and Lh may be collectively referred to as a straight line Lvh.

Multiplying both sides of Expression (1) by f₂ and solving the resultant expression for f yields Expression (2) below. The focal length f can thus be determined.

f=\sqrt{−(HxVx+HyVy)} (2)

Once the coordinates of the vertical vanishing point Vvnp and the horizontal vanishing point Hvnp are determined in the normalized camera coordinate system, an aspect ratio m of the screen frame 32 can be calculated as follows.

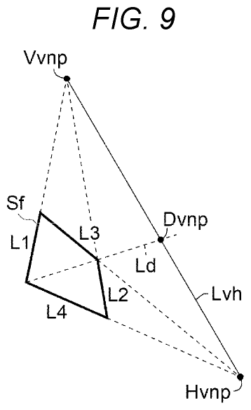

In detail, let Lvh first be the straight line that connects the vertical vanishing point Vvnp and the horizontal vanishing point Hvnp to each other, as shown in FIG. 9. The intersection of the straight line Lvh and an extension of a diagonal extension Ld of the quadrilateral Sf is defined as a diagonal vanishing point Dvnp. Once the coordinates (Dx, Dy, 1) of the diagonal vanishing point Dvnp are determined, the aspect ratio m of the screen frame 32 can be calculated by Expression (3) below.

$$m = \sqrt{\frac{{Vx}^{2} + {Vy}^{2} + 1}{{Hx}^{2} + {Hy}^{2} + 1}} \frac{( HyDx - HxDy )}{( VxDy - VyDx )} \qquad ( 3 )$$

The aspect ratio m refers to the ratio of the vertical size to the horizontal size (m:1) of the rectangular shape, specifically 4/3 (=1.33), 16/9 (=1.78), and so on. The aspect ratio m is not necessarily the ratio of the vertical size to the horizontal size (m:1), and is in some cases the ratio of the horizontal size to the vertical size (1:m).

In FIG. 9, the extension Ld of the diagonal that connects the intersection of the sides L1 and L4 and the intersection of the sides L2 and L3 intersects with the straight line Lvh. Depending on the shape of the quadrilateral Sf, however, the extension of the diagonal that connects the intersection of the sides L1 and L3 and the intersection of the sides L2 and L4 may intersect with the straight line Lvh in some cases.

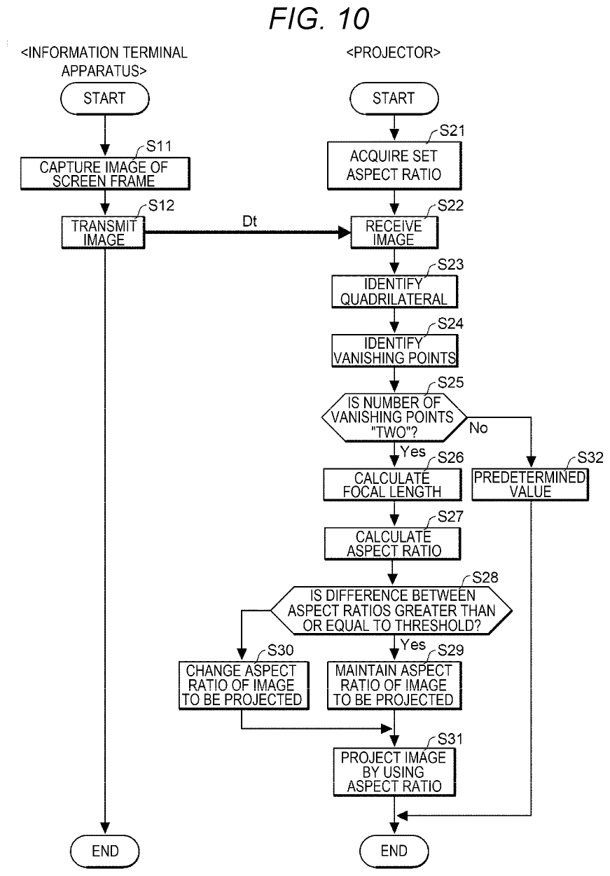

FIG. 10 is a flowchart showing a specific action of the imaging system 1.

First, in the information terminal apparatus 10, when the user activates an application program, for example, by tapping an icon displayed on the display apparatus 150, the imaging controller 102 causes the display apparatus 150 to display a message that prompts the user to capture an image of the screen frame 32. The user follows the message to capture an image of the screen frame 32, for example, by operating a software button displayed on the display apparatus 150 (step S11).

The imaging controller 102 transfers image data Dt on the captured screen frame 32 to the communication controller 106, which then controls the communication apparatus 260 to transmit the image data Dt to the projector 20 (step S12).

In the information terminal apparatus 10, the application program activated by the imaging controller 102 ends after step S12.

On the other hand, when the projector 20 is powered on, for example, by the user, the focal length f and the aspect ratio m are calculated as follows.

First, the processing controller 201 instructs the projection controller 206 to acquire the current aspect ratio (step S21). The current aspect ratio is specifically the aspect ratio of an image size specified by the image signal supplied from the host apparatus. For example, when the image data Dt specifies a horizontal image size of 1920 pixels and a vertical image size of 1080 pixels, the projection controller 206 acquires information representing that the aspect ratio is 1.78 (=1920/1080).

Having acquired the current aspect ratio, the projection controller 206 supplies the processing controller 201 with the information on the aspect ratio.

Having acquired the current aspect ratio from the projection controller 206, the processing controller 201 instructs the image acquirer 202 to receive the image data Dt from the information terminal apparatus 10 (step S22). When the communication apparatus 260 receives the image data Dt, the image acquirer 202 notifies the processing controller 201 of the reception of the image data Dt.

The processing controller 201 causes the image acquirer 202 to transfer the received image data Dt to the four side identifier 203. The processing controller 201 instructs the four side identifier 203 to perform the following analysis on the quadrilateral Sf contained in the image indicated by the image data Dt.

In detail, the processing controller 201 instructs the four side identifier 203 to determine information for identifying the four sides L1 to L4 of the quadrilateral Sf (step S23). Although each of the sides of the actual screen frame 32 is a straight line, the sides L1 to L4 of the quadrilateral Sf indicated by the image data Dt are not necessarily straight lines, and may be curved lines due to aberrations, distortion, and other effects produced by the optical system of the imaging apparatus 140. Therefore, the information for identifying the four sides L1 to L4 is information for identifying straight lines corresponding to the sides L1 to L4 in some cases, or information for identifying regression curved lines or approximately straight lines corresponding to the sides L1 to L4 in other cases.

The processing controller 201 instructs the four side identifier 203 to output the information for identifying the sides L1 to L4 to the coordinate identifier 204.

When the information for identifying the sides L1 to L4 is outputted to the coordinate identifier 204, the processing controller 201 instructs the coordinate specifier 204 to identify the coordinates of the vertical vanishing point Vvnp and the coordinates of the horizontal vanishing point Hvnp (step S24). In response to the instruction, the coordinate specifier 204 uses the intersection of the extension of the side L1 and the extension of the side L2 as the vertical vanishing point Vvnp to identify the coordinates of the vertical vanishing point Vvnp, and uses the intersection of the extension of the side L3 and the extension of the side L4 as the horizontal vanishing point Hvnp to identify the coordinates of the horizontal vanishing point Hvnp.

Having identified the coordinates, the coordinate identifier 204 translates the coordinates of the vertical vanishing point Vvnp and the coordinates of the horizontal vanishing point Hvnp in such a way that the center point Cen of the captured image coincides with the origin.

The processing controller 201 causes the coordinate identifier 204 to output the coordinates of the translated vertical vanishing point Vvnp and horizontal vanishing point Hvnp.

Depending on the shape of the quadrilateral Sf, the vertical vanishing point Vvnp and the horizontal vanishing point Hvnp cannot be identified in some cases. In this case, the coordinate identifier 204 notifies the processing controller 201 that the two vanishing points have not been identified.

The processing controller 201 evaluates whether the number of identified vanishing points is “two” based on the output or notification from the coordinate identifier 204 (step S25). When the number of vanishing points is “two”, that is, when the result of the evaluation in step S24 is “Yes”, the processing controller 201 instructs the calculator 205 to perform calculation below (step S26). In detail, the processing controller 201 causes the calculator 205 to substitute the coordinates of the vertical vanishing point Vvnp and the coordinates of the horizontal vanishing point Hvnp outputted from the coordinate identifier 204 into Expression (2) to calculate the focal length f of the imaging apparatus 140.

The processing controller 201 then causes the coordinate identifier 204 to identify the coordinates of the diagonal vanishing point Dvnp, which is the intersection of the straight line Lvh, which connects the vertical vanishing point Vvnp and the horizontal vanishing point Hvnp to each other, and the extension Ld of the diagonal of the quadrilateral Sf. The processing controller 201 then transfers the identified coordinates of the diagonal vanishing point Dvnp to the calculator 205 and causes the calculator 205 to substitute the coordinates of the diagonal vanishing point Dvnp, the coordinates of the vertical vanishing point Vvnp, and the coordinates of the horizontal vanishing point Hvnp into Expression (3) to calculate the aspect ratio m of the screen frame 32 (step S27).

The calculator 205 supplies the processing controller 201 with the determined aspect ratio m.

The processing controller 201 evaluates whether the difference between the aspect ratio acquired in step S21 and the aspect ratio m supplied in step S27, that is, the difference between the aspect ratio of an image to be projected and the aspect ratio m of the screen frame 32 determined by the calculation is greater than or equal to a threshold (step S28).

When the difference is greater than or equal to the threshold, that is, when the result of the evaluation in step S28 is “Yes”, the processing controller 201 determines to maintain the aspect ratio of the image to be projected equal to the aspect ratio acquired in step S21 (step S29).

When the difference is smaller than the threshold, that is, when the result of the evaluation in step S28 is “No”, the processing controller 201 changes the aspect ratio of the image to be projected to the aspect ratio of the screen frame 32 (step S30).

The processing controller 201 instructs the projection controller 206 to project the image signal supplied from the host apparatus by using the maintained or changed aspect ratio (step S31). In response to the instruction, the projection controller 206 causes the projection apparatus 250 to project an image based on the image signal and having the instructed aspect ratio.

When the difference between the aspect ratio of the image indicated by the image signal and the calculated aspect ratio m is greater than or equal to the threshold, the aspect ratio of the image indicated by the image signal is given priority, and the image is projected by using the aspect ratio having the priority. On the other hand, when the difference is smaller than the threshold, the aspect ratio of the image indicated by the image signal is changed in accordance with the aspect ratio m of the screen frame 32, whereby projection effectively using the screen frame 32 can, for example, be performed. In this case, the aspect ratio is changed, but the amount of the change is so small that the user does not have a feeling that something is wrong.

Note that in the step S25 described above, when the coordinate specifier 204 notifies the processing controller 201 that the identified number of vanishing points is other than “2”, that is, when the result of the evaluation in step S25 is “No”, the coordinates of each of the vanishing points are too large, or the quadrilateral is, for example, a trapezoid. In this case, the processing controller 201 uses a focal length specified in advance as the focal length of the imaging apparatus 140 in the information terminal apparatus 10 (step S32).

In the projector 20, the calculation of the focal length f and the aspect ratio m ends after step S31 or S32, but the projection based on the image signal keeps being executed.

Since a variety of apparatuses such as a smartphone and a tablet apparatus are used as the information terminal apparatus 10, it is difficult for an average user to grasp the focal length f of the imaging apparatus 140 built in the information terminal apparatus 10. However, the imaging system 1 according to the present embodiment, in which the imaging apparatus 140 of the information terminal apparatus 10 captures an image of the screen frame 32 and the information terminal apparatus 10 analyzes the captured image to determine the focal length f of the imaging apparatus 140 through calculation, can eliminate the need to capture an image of a checkerboard and can therefore save a lot of time and effort.

### Applications and Variations

The embodiment presented above by way of example can be changed in a variety of manners. Aspects of specific variations applicable to the embodiment will be presented below by way of example.

In the embodiment, the focal length f of the imaging apparatus 140 of the information terminal apparatus 10 and the aspect ratio of the projection region surrounded by the screen frame 32 may be used to perform trapezoidal correction or adjust enlargement/reduction ratio in the projector 20.

In the embodiment, the projector 20 has the functions of analyzing the quadrilateral Sf and calculating the focal length f from the coordinates of vanishing points, and the information terminal apparatus 10 may instead have the functions of analyzing the quadrilateral Sf and calculating the focal length f from the coordinates of vanishing points in addition to the imaging function. Specifically, the image acquirer 202, the four side identifier 203, the coordinate identifier 204, and the calculator 205 in the projector 20 may be provided in the information terminal apparatus 10.

The image acquirer 202, the four side identifier 203, the coordinate identifier 204, and the calculator 205 may instead be provided in a server in a cloud. For example, the image data Dt on an image captured by the information terminal apparatus 10 may be transmitted to the server via a communication network, and the server may transmit the aspect ratio determined by executing steps S22 to S27 to the projector 20.

### Remarks

The above description leads to preferable aspects of the present disclosure, for example, as follows. To facilitate the understanding of each of the aspects, the symbols in the drawings are shown below in parentheses for convenience, but it is not intended to limit the present disclosure to the illustrated aspects.

### Remark 1

A focal length calculation method according to a first aspect includes acquiring image data (Dt) produced by capturing an image of a rectangular subject (32), identifying the sides of a quadrilateral (Sf) corresponding to the subject (32), a first side (L1), a second side (L2) facing the first side (L1), a third side (L3), and a fourth side (L4) facing the third side (L3), in the image indicated by the image data (Dt), identifying the coordinates of a first point (Vvnp) that is the intersection of an extension of the first side (L1) and an extension of the second side (L2), and the coordinates of a second point (Hvnp) that is the intersection of an extension of the third side (L3) and an extension of the fourth side (L4), and calculating the focal length (f) of an apparatus (10) having captured the image of the subject (32) based on the coordinates of the first point (Vvnp) and the coordinates of the second point (Hvnp). According to the first aspect, it is not necessary to capture an image of a checkerboard to determine the focal length (f) of the apparatus (10) having captured the image of the subject, so that a lot of effort is not required.

### Remark 2

In the focal distance calculation method according to a specific second aspect of the first aspect, calculating the focal distance (f) includes determining the focal length (f) that causes the inner product of first coordinates (Vx/f, Vy/f, 1) and second coordinates (Hx/f, Hy/f, 1) to be zero, the first coordinates being the result of conversion of the coordinates of the first point (Vvnp) into those in a normalized camera coordinate system, the second coordinates being the result of conversion of the coordinates of the second point (Hvnp) into those in the normalized camera coordinate system. According to the second aspect, the focal length (f) is specifically calculated.

### Remark 3

In the focal length calculation method according to another specific third aspect of the first aspect, when the coordinates of the first point (Vvnp) are (Vx, Vy), the coordinates of the second point (Hvnp) are (Hx, Hy), the focal length (f) is calculated by using the following expression.

f={−(HxVx+HyVy)}^{1/2}

According to the third aspect, the focal length (f) is specifically calculated.

### Remark 4

A display method performed by a projector according to a fourth aspect includes acquiring image data (Dt) produced by capturing an image of a rectangular projection region (32), identifying the sides of a quadrilateral (Sf) corresponding to the projection region (32), a first side (L1), a second side (L2) facing the first side (L1), a third side (L3), and a fourth side (L4) facing the third side (L3), in the image indicated by the image data (Dt), acquiring the coordinates (Vx, Vy) of a first point (Vvnp) that is the intersection of an extension of the first side (L1) and an extension of the second side (L2), and the coordinates (Hx, Hy) of a second point (Hvnp) that is the intersection of an extension of the third side (L3) and an extension of the fourth side (L4), calculating the focal length (f) of an apparatus (10) having captured the image of the projection region (32) based on the coordinates (Vx, Vy) of the first point (Vvnp) and the coordinates (Hx, Hy) the second point (Hvnp), identifying the coordinates (Dx, Dy) of a third point (Dvnp) that is the intersection of the straight line (Lvh) that connects the first point (Vvnp) and the second point (Hvnp) to each other and an extension (Ld) of the diagonal of the quadrilateral (Sf), calculating the aspect ratio (m) of the projection region (32) based on the coordinates (Vx, Vy) of the first point (Vvnp), the coordinates (Hx, Hy) of the second point (Hvnp), and the coordinates (Dx, Dy) of the third point (Dvnp), and projecting an image based on the calculated aspect ratio (m) of the projection region (32).

According to the fourth aspect, it is not necessary to capture an image of a checkerboard to determine the focal length (f) of the apparatus (10) having captured an image of the projection region (32), so that a lot of effort is not required. Furthermore, appropriate projection based on the calculated aspect ratio (m) of the projection region (32) can be performed.

### Remark 5

In the display method performed by a projector according to a specific fifth aspect of the fourth aspect, when the difference between the aspect ratio of an image indicated by an image signal and the aspect ratio (m) of the projection region (32) is greater than or equal to a threshold, the image is projected by using the aspect ratio of the image indicated by the image signal. According to the fifth aspect, in this case, the aspect ratio of the image indicated by the image signal is given priority, and the image is projected by using the aspect ratio having the priority.

### Remark 6

In the display method performed by a projector according to another specific sixth aspect of the fourth aspect, when the difference between the aspect ratio of the image indicated by the image signal and the aspect ratio (m) of the projection region (32) is smaller than the threshold, the image is projected by using an aspect ratio produced by changing the aspect ratio of the image indicated by the image signal to the aspect ratio (m) of the projection region (32). According to the sixth aspect, in this case, the image is displayed across the entire projection region (32), and even when the aspect ratio of the image indicated by the image signal is changed, the change is so small that the user does not have a feeling that something is wrong.

### Remark 7

An imaging system (1) according to a seventh aspect includes a processor (200), and the processor (200) acquires image data (Dt) produced by capturing an image of a rectangular subject (32), identifies the sides of a quadrilateral (Sf) corresponding to the subject (32), a first side (L1), a second side (L2) facing the first side (L1), a third side (L3), and a fourth side (L4) facing the third side (L3), in the image indicated by the image data (Dt), acquires the coordinates (Vx, Vy) of a first point (Vvnp) that is the intersection of an extension of the first side (L1) and an extension of the second side (L2), and the coordinates (Hx, Hy) of a second point (Hvnp) that is the intersection of an extension of the third side (L3) and an extension of the fourth side (L4), and calculates the focal length (f) of an apparatus (10) having captured the image of the subject (32) based on the coordinates (Vx, Vy) of the first point (L1) and the coordinates (Hx, Hy) of the second point (L2). According to the seventh aspect, it is not necessary to capture an image of a checkerboard to determine the focal length (f) of the apparatus (10) having captured the image of the subject, so that a lot of

What is claimed is:

1. A focal length calculation method comprising:
acquiring image data produced by capturing an image of a rectangular subject;
identifying sides of a quadrilateral corresponding to the subject, a first side, a second side facing the first side, a third side, and a fourth side facing the third side, in the image indicated by the image data;
identifying coordinates of a first point that is an intersection of an extension of the first side and an extension of the second side, and coordinates of a second point that is an intersection of an extension of the third side and an extension of the fourth side; and
calculating a focal length of an apparatus that captures the image of the subject based on the coordinates of the first point and the coordinates of the second point.

2. The focal distance calculation method according to claim 1,
wherein calculating the focal distance includes determining the focal length that causes an inner product of first coordinates and second coordinates to be zero, the first coordinates being a result of conversion of the coordinates of the first point into coordinates in a normalized camera coordinate system, the second coordinates being a result of conversion of the coordinates of the second point into coordinates in the normalized camera coordinate system.

3. In the focal length calculation method according to claim 1,
wherein when the coordinates of the first point are (Vx, Vy), the coordinates of the second point are (Hx, Hy), and the focal length is f, the focal length f is calculated by using the following expression.
f={−(HxVx+HyVy)}^{1/2}

4. A display method performed by a projector, the method comprising:
acquiring image data produced by capturing an image of a rectangular projection region;
identifying sides of a quadrilateral corresponding to the projection region, a first side, a second side facing the first side, a third side, and a fourth side facing the third side, in the image indicated by the image data;
identifying coordinates of a first point that is an intersection of an extension of the first side and an extension of the second side, and coordinates of a second point that is an intersection of an extension of the third side and an extension of the fourth side;
calculating a focal length of an apparatus that captures the image of the projection region based on the coordinates of the first point and the coordinates the second point;
identifying coordinates of a third point that is an intersection of a straight line that connects the first point and the second point to each other and an extension of a diagonal of the quadrilateral;
calculating an aspect ratio of the projection region based on the coordinates of the first point, the coordinates of the second point, and the coordinates of the third point; and
projecting the image based on the calculated aspect ratio of the projection region.

5. The display method performed by a projector according to claim 4,
wherein when a difference between the aspect ratio of an image indicated by an image signal and the aspect ratio of the projection region is greater than or equal to a threshold, the image is projected by using the aspect ratio of the image indicated by the image signal.

6. The display method performed by a projector according to claim 4,
wherein when a difference between the aspect ratio of an image indicated by an image signal and the aspect ratio of the projection region is smaller than a threshold, the image is projected by using an aspect ratio produced by changing the aspect ratio of the image indicated by the image signal to the aspect ratio of the projection region.

7. An imaging system comprising
a processor,
wherein the processor
acquires image data produced by capturing an image of a rectangular subject,
identifies sides of a quadrilateral corresponding to the subject, a first side, a second side facing the first side, a third side, and a fourth side facing the third side, in the image indicated by the image data,
identifies coordinates of a first point that is an intersection of an extension of the first side and an extension of the second side, and coordinates of a second point that is an intersection of an extension of the third side and an extension of the fourth side, and
calculates a focal length of an apparatus that captures the image of the subject based on the coordinates of the first point and the coordinates of the second point.
